(19) United States
(12) Patent Application Publication
(10) Pub. No.: US 2025/0356067 A1
(43) Pub. Date: Nov. 20, 2025

(54) DESIGN DRAWING PROCESSING METHOD AND SYSTEM, AND ELECTRONIC DEVICE AND STORAGE MEDIUM

(71) Applicant: CHINA CONSTRUCTION STEEL STRUCTURE CO., LTD., Shenzhen, Guangdong (CN)

(72) Inventors: Zhenming CHEN, Shenzhen, Guangdong (CN); Hongming WU, Shenzhen, Guangdong (CN); Zhiqiang WANG, Shenzhen, Guangdong (CN); Lei JIANG, Shenzhen, Guangdong (CN); Ran XIN, Shenzhen, Guangdong (CN); Peng WANG, Shenzhen, Guangdong (CN); Huan CHEN, Shenzhen, Guangdong (CN)

(21) Appl. No.: 18/861,032

(22) PCT Filed: Sep. 19, 2022
(86) PCT No.: PCT/CN2022/119714

§ 371 Date: Oct. 28, 2024

(30) Foreign Application Priority Data
Jul. 25, 2022 (CN) 2022108757851

(51) Int. Cl. G06F 30/12; G06T 11/20

(52) U.S. Cl. CPC G06F 30/12; G06T 11/203

(57) ABSTRACT

A method and system for processing a design drawing, an electronic device and a storage medium are disclosed. The method includes: acquiring, from a target application, first coordinate data of a first endpoint, second coordinate data of a second endpoint, first radius data of a first node and second radius data of a second node; obtaining first circle-center coordinate data of the first node according to the first coordinate data, the second coordinate data and the first radius data; obtaining second circle-center coordinate data of the second node according to the first coordinate data, the second coordinate data and the second radius data; and performing a first connection operation on a lofting line segment according to the first circle-center coordinate data and the first coordinate data, and performing a second connection operation on the lofting line segment according to the second circle-center coordinate data and the second coordinate data.

### CROSS-REFERENCE TO RELATED APPLICATIONS

This application is a national stage filing under 35 U.S.C. § 371 of international application number PCT/CN2022/119714, filed Sep. 19, 2022, which claims priority to Chinese patent application No. 202210875785.1 filed Jul. 25, 2022. The contents of these applications are incorporated herein by reference in their entirety.

### TECHNICAL FIELD

The present disclosure relates to the technical field of engineering design, and particularly to a design drawing processing method and system, and an electronic device and a storage medium.

### BACKGROUND

At present, design drawings are used for modeling the roof truss structures for various facilities, such as industrial plants, airports, and stadiums. These truss structures include a plurality of rods and a plurality of spherical members, and the rods and the spherical members are alternately connected with each other. In a design drawing corresponding to the truss structure, a lofting line segment is used for representing the rod, and a circular node is used for representing the spherical member. In actual operation, that is, in the process of mounting the facilities described above according to the design drawing of the truss structure, the rods are connected with each other, and the spherical members are mounted on joints between two adjacent rods to stabilize the connection of the rods. However, in the design drawing, the circular node may shield an intersection point between two lofting line segments, that is, two adjacent lofting line segments in the design drawing are not intersected. This can lead to positioning errors during mounting of the rods based on the design drawing for the truss structure, thereby resulting in the low dimensional accuracy for the whole truss structure.

In the related art, the above problem has been addressed by manually connecting adjacent lofting line segments in the design drawing. However, for complex design drawings, manual connections can become very cumbersome, leading to the low design efficiency. Meanwhile, the manual connections may also have the problem of low connection accuracy.

### SUMMARY

The present disclosure aims to solve at least one of the technical problems in the existing technology. Therefore, the present disclosure provides a method for processing a design drawing, which can enable all two adjacent lofting line segments in a design drawing to intersect at circle centers of the respective nodes, thereby improving the design efficiency.

The present disclosure further provides a system for processing a design drawing, and an electronic device applying the method for processing a design drawing above and a computer-readable storage medium applying the method for processing a design drawing above.

In a method for processing a design drawing according to an embodiment in a first aspect of the present disclosure, the design drawing includes a plurality of connection assemblies, each of the connection assemblies includes a first node, a second node and a lofting line segment, the lofting line segment includes a first endpoint and a second endpoint, the first endpoint is connected with the first node, the second endpoint is connected with the second node, and the first node and the second node are both circular, and the method includes:
acquiring, from a target application, first coordinate data of the first endpoint, second coordinate data of the second endpoint, first radius data of the first node and second radius data of the second node:
obtaining first circle-center coordinate data of the first node according to the first coordinate data, the second coordinate data and the first radius data:
obtaining second circle-center coordinate data of the second node according to the first coordinate data, the second coordinate data and the second radius data; and
performing a first connection operation on the lofting line segment according to the first circle-center coordinate data and the first coordinate data, and performing a second connection operation on the lofting line segment according to the second circle-center coordinate data and the second coordinate data.

The method for processing a design drawing according to the embodiment of the present disclosure has at least the following beneficial effects. The first coordinate data of the first endpoint, the second coordinate data of the second endpoint, the first radius data of the first node and the second radius data of the second node are acquired first. The first endpoint and the second endpoint are two endpoints of the lofting line segment, the first endpoint is connected with the first node, the second endpoint is connected with the second node, and the first node and the second node are both circular. After acquiring the data above, the first circle-center coordinate data of the first node is obtained according to the first coordinate data, the second coordinate data and the first radius data, and the second circle-center coordinate data of the second node is obtained according to the first coordinate data, the second coordinate data and the second radius data. Finally, the first connection operation is performed on the lofting line segment according to the first circle-center coordinate data and the first coordinate data, and the second connection operation is performed on the lofting line segment according to the second circle-center coordinate data and the second coordinate data. That is, two ends of the lofting line segment are extended, with one end of the lofting line segment being extended to a circle center of the first node, and the other end of the lofting line segment being extended to a circle center of the second node. In this way, all two adjacent lofting line segments in the design drawing can intersect at circle centers of the respective circular nodes. The method for processing a design drawing in this embodiment can enable all two adjacent lofting line segments in the design drawing to intersect at circle centers of the respective nodes, thereby improving the design efficiency. Meanwhile, the method for processing a design drawing in this embodiment can accurately determine the intersection points of all two adjacent lofting line segments, thereby improving the connection accuracy of the design drawing.

According to some embodiments of the present disclosure, obtaining the first circle-center coordinate data of the first node according to the first coordinate data, the second coordinate data and the first radius data, includes:
obtaining length data of the lofting line segment according to the first coordinate data and the second coordinate data; and
obtaining the first circle-center coordinate data of the first node according to the length data, the first radius data and the first coordinate data.

According to some embodiments of the present disclosure, the length data includes first line segment length data, first projection length data and second projection length data. The first projection length data is used for representing projection length data of the lofting line segment in a first direction, the second projection length data is used for representing projection length data of the lofting line segment in a second direction, and the second direction is perpendicular to the first direction.

Obtaining the first circle-center coordinate data of the first node according to the length data and the first radius data, includes:
obtaining third projection length data and fourth projection length data according to the first line segment length data, the first projection length data, the second projection length data and the first radius data: wherein, the third projection length data is used for representing projection length data of a radius of the first node in the first direction, and the fourth projection length data is used for representing projection length data of the radius of the first node in the second direction; and
obtaining the first circle-center coordinate data of the first node according to the third projection length data, the fourth projection length data and the first coordinate data.

According to some embodiments of the present disclosure, obtaining the second circle-center coordinate data of the second node according to the first coordinate data, the second coordinate data and the second radius data, includes:
obtaining length data of the lofting line segment according to the first coordinate data and the second coordinate data; and
obtaining the second circle-center coordinate data of the second node according to the length data, the second radius data and the second coordinate data.

According to some embodiments of the present disclosure, obtaining the second circle-center coordinate data of the second node according to the length data, the second radius data and the second coordinate data, includes:
obtaining fifth projection length data and sixth projection length data according to the first line segment length data, the first projection length data, the second projection length data and the second radius data: wherein, the fifth projection length data is used for representing projection length data of a radius of the second node in the first direction, and the sixth projection length data is used for representing projection length data of the radius of the second node in the second direction; and
obtaining the second circle-center coordinate data of the second node according to the fifth projection length data, the sixth projection length data and the second coordinate data.

According to some embodiments of the present disclosure, the target application includes AutoCAD.

A system for processing a design drawing is provided according to an embodiment in a second aspect of the present disclosure, which includes:
a first processing module configured for acquiring, from a target application, first coordinate data of a first endpoint, second coordinate data of a second endpoint, first radius data of a first node and second radius data of a second node:
a second processing module configured for obtaining first circle-center coordinate data of the first node according to the first coordinate data, the second coordinate data and the first radius data; and obtaining second circle-center coordinate data of the second node according to the first coordinate data, the second coordinate data and the second radius data; and
an extension module configured for performing a first connection operation on a lofting line segment according to the first circle-center coordinate data and the first coordinate data, and performing a second connection operation on the lofting line segment according to the second circle-center coordinate data and the second coordinate data.

The system for processing a design drawing according to the embodiment of the present disclosure has at least the following beneficial effects. By adopting the method for processing a design drawing above, all two adjacent lofting line segments in the design drawing are enabled to intersect at circle centers of the respective nodes, thereby improving the design efficiency. Meanwhile, by adopting the method for processing a design drawing above, the intersection points of all two adjacent lofting line segments are accurately determined, thereby improving the connection accuracy of the design drawing.

An electronic device is provided according to an embodiment in a third aspect of the present disclosure, which includes:
at least one processor, and a memory in communication connection with the at least one processor:
wherein, the storage stores instructions which, when executed by the at least one processor, cause the at least one processor to implement the method for processing a design drawing according to the embodiment in the first aspect above.

A computer-readable storage medium is provided according to an embodiment in a fourth aspect of the present disclosure, which stores computer-executable instructions for enabling a computer to execute the method for processing a design drawing according to the embodiment in the first aspect above.

Additional aspects and advantages of the present disclosure will be given in part in the following description, which will become apparent from the following description or be understood through practice of the present disclosure.

### BRIEF DESCRIPTION OF THE DRAWINGS

The present disclosure is further described hereinafter with reference to the drawings and embodiments, wherein:

FIG. 1 is a schematic diagram of a design drawing in the related art;

FIG. 2 is a flowchart of a method for processing a design drawing according to an embodiment of the present disclosure:

FIG. 3 is a schematic diagram showing a lofting line segment, a first node and a second node in the method for processing a design drawing according to an embodiment of the present disclosure:

FIG. 4 is a flowchart of the method for processing a design drawing according to another embodiment of the present disclosure;

FIG. 5 is a flowchart of the method for processing a design drawing according to another embodiment of the present disclosure:

FIG. 6 is a flowchart of the method for processing a design drawing according to another embodiment of the present disclosure;

FIG. 7 is a flowchart of the method for processing a design drawing according to another embodiment of the present disclosure; and

FIG. 8 is a module block diagram of a system for processing a design drawing according to an embodiment of the present disclosure.

### REFERENCE NUMERALS

100 refers to lofting line segment, 200 refers to first node, 300 refers to second node, 400 refers to first processing module, 500 refers to second processing module, and 600 refers to extension module.

### DETAILED DESCRIPTION

Embodiments of the present disclosure will be described in detail below. Examples of the embodiments are illustrated in the accompanying drawings, where the same or like reference numerals throughout the figures indicate the same or like elements having the same or like functions. The embodiments described below with reference to the accompanying drawings are exemplary and are intended only to explain the present disclosure instead of being construed as limiting the present disclosure.

In the description of the present disclosure, it should be understood that, descriptions relating to orientation, for example, orientation or positional relationships indicated by “up”, “down”, “front”, “back”, “left”, “right”, etc. are based on the orientation or positional relationships shown in the accompanying drawings, and are to facilitate the description of the present disclosure and simplify the description only, rather than indicating or implying that the device or element referred to must have a specific orientation or be constructed and operated in a specific orientation, and therefore cannot be construed as limiting the present disclosure.

In the description of the present disclosure, the meaning of “several” is one or more, the meaning of “a plurality of” is two or more, “greater than”, “less than”, “more than”, etc. are to be understood to exclude the given figure, and “above”, “below”, “within”, etc. are understood to include the given figure. If “first” and “second”, etc. are referred to, it is only for the purpose of distinguishing technical features, and shall not be understood as indicating or implying relative importance or implying the number of the indicated technical features or implying the sequence of the indicated technical features.

In the description of the present disclosure, unless otherwise explicitly defined, the words such as “set”, “install”, and “connect” should be understood in a broad sense, and those skilled in the art can determine the specific meanings of the above words in the present disclosure in a rational way in combination with the specific contents of the technical solutions.

In the description of the present disclosure, the descriptions with reference to the terms “an embodiment”, “some embodiments”, “schematic embodiments”, “example”, “specific example”, or “some examples” refer to that the specific features, structures, materials, or characteristics described in combination with the embodiment or example are included in at least one embodiment or example of the present disclosure. In the specification, the schematic representation of the above terms does not necessarily mean the same embodiment or example. Moreover, the specific features, structures, materials or characteristics described may be combined in any one or more embodiments or examples in a suitable manner.

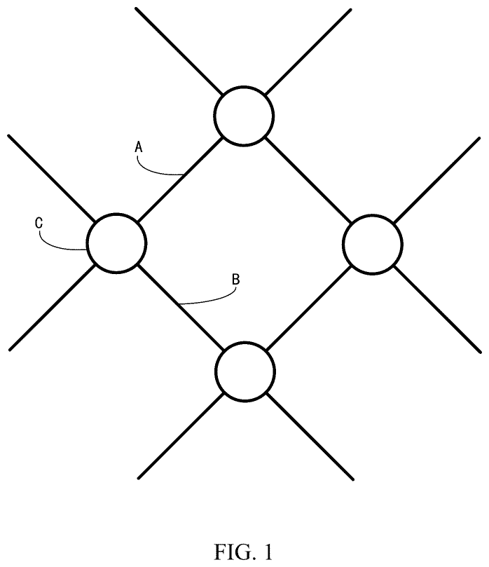

In the related art, a circular node in a design drawing may shield an intersection point between two lofting line segments, and in a corresponding truss structure of the design drawing, the lofting line segment is used for representing a rod, and the circular node is used for representing a spherical member. As shown in FIG. 1, an intersection point between a lofting line segment A and a lofting line segment B is shielded by a circular node C. However, in actual operation, two rods corresponding to the line segment A and the line segment B are connected with each other, and after connecting the rods with each other, a spherical member corresponding to the circular node C is mounted on a joint between two rods to stabilize the connection of the rods. The joint between two adjacent rods in the truss structure should be located at a circle center of the spherical member, that is, the intersection point of two adjacent lofting line segments A and B in the corresponding design drawing should be located at a circle center of the circular node C. If two adjacent lofting line segments in the design drawing are not intersected, there may be positioning errors during mounting of the rods based on the design drawing for the truss structure, thereby resulting in the low dimensional accuracy for the whole 10) truss structure. In the existing technology, the above problem has been addressed by manually connecting adjacent lofting line segments to form one intersection point. However, for complex design drawings, for example, with too many lofting line segments and circular nodes, manual connections can become very cumbersome, leading to the low design efficiency. Meanwhile, the manual connection method may also have the problem of low connection accuracy.

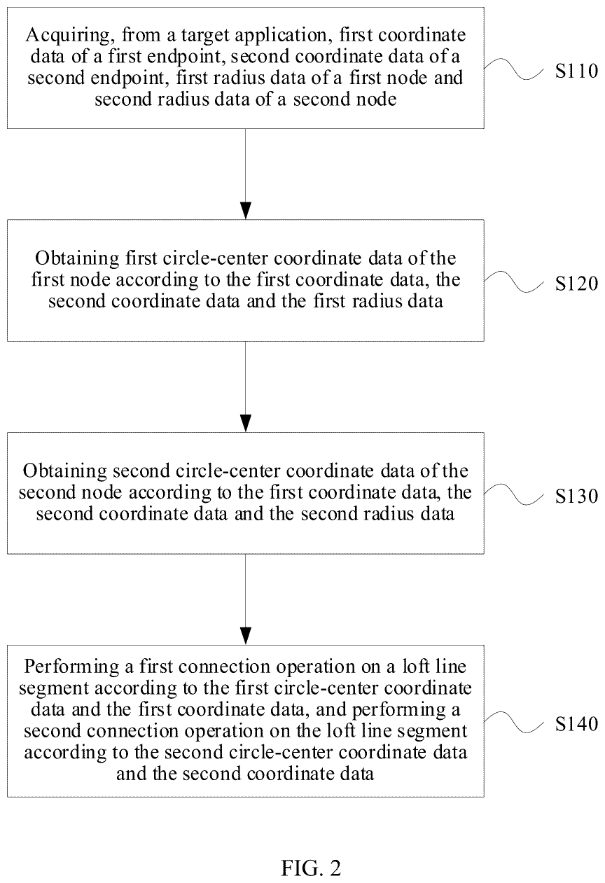

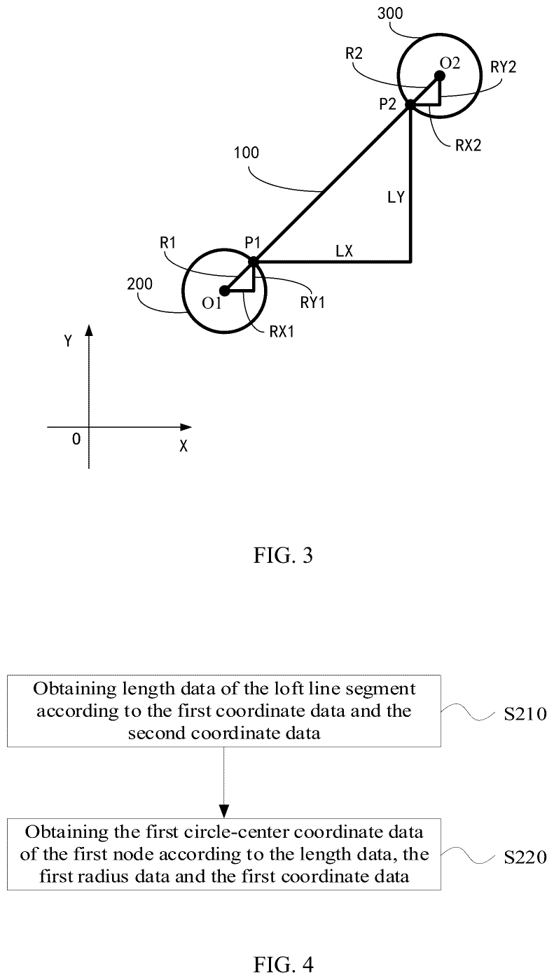

As shown in FIG. 2 and FIG. 3, an embodiment of the present disclosure provides a method for processing a design drawing. The design drawing includes a plurality of connection assemblies, each of the connection assemblies includes a lofting line segment 100, a first node 200 and a second node 300, the lofting line segment 100 includes a first endpoint and a second endpoint, the first endpoint is connected with the first node 200, the second endpoint is connected with the second node 300, and the first node 200 and the second node 300 are both circular. The method for processing a design drawing includes, but is not limited to, steps S110 to step S140.

In S110, first coordinate data of the first endpoint, second coordinate data of the second endpoint, first radius data of the first node and second radius data of the second node are acquired from a target application.

Specifically, the lofting line segment 100 represents any rod in an actual truss structure, and the first endpoint and the second endpoint represent two ends of the rod. The first node 200 represents a spherical member connected with one end of the above rod in the actual truss structure, and the second node 300 represents another spherical member connected with the other end of the above rod in the actual truss structure. FIG. 3 is a schematic diagram showing the first node 200, the second node 300) and the lofting line segment 100 captured from the design drawing. With reference to FIG. 3, the first coordinate data are coordinates of the first endpoint P1 of the lofting line segment 100 in a coordinate system O-XY, and the second coordinate data are coordinates of the second endpoint P2 of the lofting line segment 100 in the coordinate system O-XY. The target application is a device or software with a graphic data acquisition function, and the target application can acquire the coordinates of the first endpoint P1, the coordinates of the second endpoint P2, a radius of the first node 200 and a radius of the second node 300 from the design drawing.
In S120, first circle-center coordinate data of the first node is obtained according to the first coordinate data, the second coordinate data and the first radius data.
In S130, second circle-center coordinate data of the second node is obtained according to the first coordinate data, the second coordinate data and the second radius data.
In S140, a first connection operation is performed on the lofting line segment according to the first circle-center coordinate data and the first coordinate data, and a second connection operation is performed on the lofting line segment according to the second circle-center coordinate data and the second coordinate data.

Specifically, with reference to FIG. 3, coordinates of a first circle center O1 of the first node 200 may be solved through the first coordinate data (which is namely the coordinates of the first endpoint P1), the second coordinate data (which is namely the coordinates of the second endpoint P2) and the first radius data (which is namely the first radius R1 of the first node 200) acquired in the previous steps. Coordinates of a second circle center O2 of the second node 300 may be solved through the first coordinate data (which is namely the coordinates of the first endpoint P1), the second coordinate data (which is namely the coordinates of the second endpoint P2) and the second radius data (which is namely the radius R2 of the second node 300) acquired in the previous steps. Further, the first connection operation is performed between the first endpoint P1 and the first circle center O1 of the first node 200, and the second connection operation is performed between the second endpoint P2 and the second circle center O2 of the second node 300, so as to obtain an extended line segment of the lofting line segment 100, wherein the extended line segment takes the first circle center O1 of the first node 200 as one end and takes the second circle center O2 of the second node 300 as the other end. By performing the first connection operation and the second connection operation on all lofting line segments 100 in the design drawing in this embodiment, all two adjacent lofting line segments in the design drawing can intersect at circle centers of respective circular nodes where the two lofting line segments are connected, thereby improving the design efficiency of the design drawing.

In the method for processing a design drawing according to the embodiment of the present disclosure, the first circle-center coordinate data of the first node is obtained according to the first coordinate data, the second coordinate data and the first radius data, and the second circle-center coordinate data of the second node is obtained according to the first coordinate data, the second coordinate data and the second radius data. The first connection operation is performed on the lofting line segment according to the first circle-center coordinate data and the first coordinate data, and the second connection operation is performed on the lofting line segment according to the second circle-center coordinate data and the second coordinate data, so as to extend two ends of the lofting line segment. One end of the lofting line segment is extended to a circle center of the first node, and the other end of the lofting line segment is extended to a circle center of the second node. In this way, all two adjacent lofting line segments in the design drawing can intersect at circle centers of the respective circular nodes. The method for processing a design drawing of this embodiment can enable all two adjacent lofting line segments in the design drawing to intersect at circle centers of the respective nodes, thereby improving the design efficiency. Meanwhile, the method for processing a design drawing of this embodiment can accurately determine the intersection points of all two adjacent lofting line segments, thereby improving the connection accuracy of the design drawing.

As shown in FIG. 3 and FIG. 4, in some embodiments of the present disclosure, step S120) includes, but is not limited to, sub-step S210 to sub-step S220.
In S210, length data of the lofting line segment is obtained according to the first coordinate data and the second coordinate data.
In S220, the first circle-center coordinate data of the first node is obtained according to the length data, the first radius data and the first coordinate data.

Specifically, with reference to FIG. 3, after acquiring the first coordinate data (which is namely the coordinates of the first endpoint P1) and the second coordinate data (which is namely the coordinates of the second endpoint P2), the length data of the lofting line segment 100 may be obtained according to the coordinates of the first endpoint P1 and the coordinates of the second endpoint P2. For example, the length data includes a length of the lofting line segment 100 and lengths of the other two line segments connected with each other, and the other two line segments connected 25 with each other can be connected with the lofting line segment 100 to form a first triangle. After obtaining the length data of the lofting line segment 100, the coordinates of the first circle center O1 of the first node 200 may be calculated according to the first radius data (which is namely the first radius R1 of the first node 200), the above length data and the first coordinate data (which is namely the coordinates of the first end P1). For example, by a similar triangle principle, according to various side lengths of the above first triangle, various side lengths of a second triangle with the first radius R1 of the first node 200 as one side may be calculated, and then the coordinates of the first circle center O1 of the first node 200 may be calculated by taking the coordinates of the first endpoint P1 as a reference point.

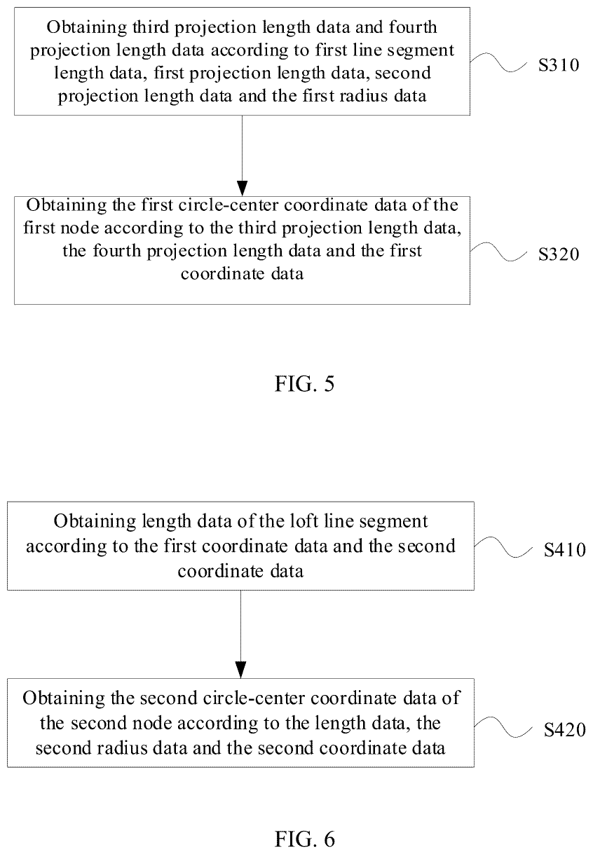

As shown in FIG. 3 and FIG. 5, in some embodiments of the present disclosure, the length data includes first line segment length data, first projection length data and second projection length data. The first projection length data is used for representing projection length data of the lofting line segment 100 in a first direction, the second projection length data is used for representing projection length data of the lofting line segment 100 in a second direction, and the second direction is perpendicular to the first direction. Step S220 includes, but is not limited to, sub-step S310 to sub-step S320.

In S310, third projection length data and fourth projection length data are obtained according to the first line segment length data, the first projection length data, the second projection length data and the first radius data.

In S320, the first circle-center coordinate data of the first node is obtained according to the third projection length data, the fourth projection length data and the first coordinate data.

The third projection length data is used for representing projection length data of the radius of the first node in the first direction, and the fourth projection length data is used for representing projection length data of the radius of the first node in the second direction.

Specifically, the first direction is a direction of an X axis in the coordinate system O-XY, the second direction is a direction of a Y axis in the coordinate system O-XY, and the first direction and the second direction are perpendicular to each other. The first line segment length data represents a length of the lofting line segment 100, the first projection length data represents a projection length of the lofting line segment 100 on the X axis, the second projection length data represents a projection length of the lofting line segment 100 on the Y axis, the third projection length data represents a projection length of the first radius R1 of the first node 200 on the X axis, and the fourth projection length data represents a projection length of the first radius R1 of the first node 200 on the Y axis. In FIG. 3, a first projection LX refers to projection of the lofting line segment 100 on the X axis, a second projection LY refers to projection of the lofting line segment 100 on the Y axis, a third projection RX1 refers to projection of the first radius R1 on the X axis, and a fourth projection RY1 refers to projection of the first radius R1 on the Y axis. The first projection LX and the second projection LY are perpendicular to each other, and the first projection LX, the second projection LY and the lofting line segment 100 enclose to form a first right triangle. The third projection RX1 and the fourth projection RY1 are perpendicular to each other, and the third projection RX1, the fourth projection RY1 and the first radius R1 enclose to form a second right triangle.

After acquiring the first coordinate data (which is namely the coordinates of the first endpoint P1) and the second coordinate data (which is namely the coordinates of the second endpoint P2), a length of the first projection LX may be obtained by subtracting an X-axis coordinate of the first endpoint P1 from an X-axis coordinate of the second endpoint P2, and a length of the second projection LY may be obtained by subtracting a Y-axis coordinate of the first endpoint P1 from a Y-axis coordinate of the second endpoint P2. Then, the length of the lofting line segment 100 may be calculated through the Pythagorean theorem by using the length of the first projection LX and the length of the second projection LY.

The length of the first projection LX is assumed to be lx, the length of the second projection LY is assumed to be ly, the length of the lofting line segment 100 is assumed to be l, the length of the first radius R1 is assumed to be r1, the length of the third projection RX1 is assumed to be rx1, and the length of the fourth projection is assumed to be ry1. According to the similar triangle principle, the following formulas (1) and (2) may be obtained:

$$rx 1 = \frac{r 1 * lx}{l} \qquad formula ( 1 )$$

$$ry 1 = \frac{r 1 * ly}{l} . \qquad formula ( 2 )$$

Because the length lx of the first projection LX, the length ly of the second projection LY, the length/of the lofting line segment 100 and the length r1 of the first radius R1 are known, the length rx1 of the third projection RX1 and the length ry1 of the fourth projection RY1 may be obtained through formula (1) and formula (2).

Because two ends of the first radius R1 are the first circle center O1 of the first node 200 and the first endpoint P1 respectively, the X-axis coordinate of the first circle center O1 may be obtained according to the length rx1 of the third projection RX1 and the X-axis coordinate of the first endpoint P1; and the Y-axis coordinate of the first circle center O1 may be obtained according to the length ry1 of the fourth projection RY1 and the Y-axis coordinate of the first endpoint P1. At this point, the coordinates of the first circle center O1 of the first node 200 may be obtained.

As shown in FIG. 3 and FIG. 6, in some embodiments of the present disclosure, step S130 includes, but is not limited to, sub-step S410 to sub-step S420.

In S410, length data of the lofting line segment is obtained according to the first coordinate data and the second coordinate data.

In S420, the second circle-center coordinate data of the second node is obtained according to the length data, the second radius data and the second coordinate data.

Specifically, with reference to FIG. 3, after acquiring the first coordinate data (which is namely the coordinates of the first endpoint P1) and the second coordinate data (which is namely the coordinates of the second endpoint P2), the length data of the lofting line segment 100 may be obtained according to the coordinates of the first endpoint P1 and the coordinates of the second endpoint P2. For example, the length data includes a length of the lofting line segment 100 and lengths of the other two line segments connected with each other, and the other two line segments connected with each other can be connected with the lofting line segment 100 to form a first triangle. After obtaining the length data of the lofting line segment 100, the coordinates of the second circle center O2 of the second node 300 may be calculated according to the second radius data (which is namely the second radius R2 of the second node 300), the above length data and the second coordinate data (which is namely the coordinates of the second endpoint P2). For example, by a similar triangle principle, according to various side lengths of the above first triangle, various side lengths of a third triangle with the second radius R2 of the second node 300 as one side may be calculated, and then the coordinates of the second circle center O2 of the second node 300 may be calculated by taking the coordinates of the second endpoint P2 as a reference point.

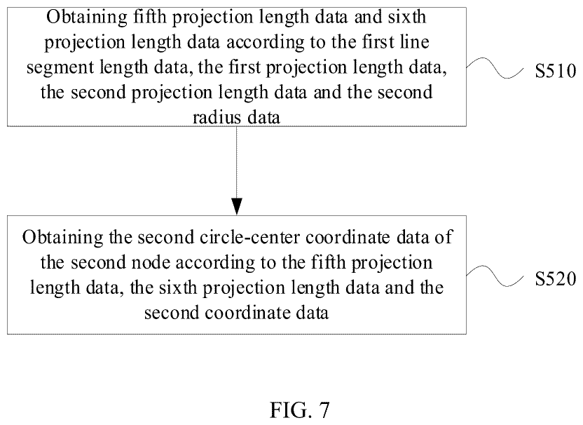

As shown in FIG. 3 and FIG. 7, in some embodiments of the present disclosure, step S420 includes, but is not limited to, sub-step S510 to sub-step S520.

In S510, fifth projection length data and sixth projection length data are obtained according to the first line segment length data, the first projection length data, the second projection length data and the second radius data.

In S520, the second circle-center coordinate data of the second node is obtained according to the fifth projection length data, the sixth projection length data and the second coordinate data.

The fifth projection length data is used for representing projection length data of a radius of the second node in the first direction, and the sixth projection length data is used for representing projection length data of the radius of the second node in the second direction.

Specifically, the first direction is a direction of an X axis in the coordinate system O-XY, the second direction is a direction of a Y axis in the coordinate system O-XY, and the first direction and the second direction are perpendicular to each other. The first line segment length data represents a length of the lofting line segment 100, the first projection length data represents a projection length of the lofting line segment 100 on the X axis, the second projection length data represents a projection length of the lofting line segment 100 on the Y axis, the fifth projection length data represents a projection length of the second radius R2 of the second node 300 on the X axis, and the sixth projection length data represents a projection length of the second radius R2 of the second node 300 on the Y axis. In FIG. 3, a first projection LX refers to projection of the lofting line segment 100 on the X axis, a second projection LY refers to projection of the lofting line segment 100 on the Y axis, a fifth projection RX2 refers to projection of the second radius R2 on the X axis, and a sixth projection RY2 refers to projection of the second radius R2 on the Y axis. The first projection LX and the second projection LY are perpendicular to each other, and the first projection LX, the second projection LY and the lofting line segment 100 enclose to form a first right triangle. The fifth projection RX2 and the sixth projection RY2 are perpendicular to each other, and the fifth projection RX2, the sixth projection RY2 and the second radius R2 enclose to form a third right triangle.

After acquiring the first coordinate data (which is namely the coordinates of the first endpoint P1) and the second coordinate data (which is namely the coordinates of the second endpoint P2), a length of the first projection LX may be obtained by subtracting X-axis coordinate of the first endpoint P1 from X-axis coordinate of the second endpoint P2, and a length of the second projection LY may be obtained by subtracting Y-axis coordinate of the first endpoint P1 from Y-axis coordinate of the second endpoint P2. Then, the length of the lofting line segment 100 may be calculated through the Pythagorean theorem by using the length of the first projection LX and the length of the second projection LY.

The length of the first projection LX is assumed to be lx, the length of the second projection LY is assumed to be ly, the length of the lofting line segment 100 is assumed to be l, the length of the second radius R2 is assumed to be r2, the length of the fifth projection RX2 is assumed to be rx2, and the length of the sixth projection is assumed to be ry2. According to the similar triangle principle, the following formulas (3) and (4) may be obtained:

$$rx 2 = \frac{r 2 * lx}{l} \qquad formula ( 3 )$$

$$ry 2 = \frac{r 2 * ly}{l} . \qquad formula ( 4 )$$

Because the length lx of the first projection LX, the length ly of the second projection LY, the length/of the lofting line segment 100 and the length r2 of the second radius R2 are known, the length rx2 of the fifth projection RX2 and the length ry2 of the sixth projection RY2 may be obtained through formula (3) and formula (4).

Because two ends of the second radius R2 are the second circle center O2 of the second node 300 and the second endpoint P2 respectively, the X-axis coordinate of the second circle center O2 may be obtained according to the length rx2 of the fifth projection RX2 and the X-axis coordinate of the second endpoint P2; and the Y-axis coordinate of the second circle center O2 may be obtained according to the length ry2 of the sixth projection RY2 and the Y-axis coordinate of the second endpoint P2. At this point, the coordinates of the second circle center O2 of the second node 300 may be obtained.

In some embodiments of the present disclosure, the target application includes AutoCAD.

Specifically, the AutoCAD is drawing software with graphic editing and data exchanging functions. The AutoCAD is used to open the design drawing in this embodiment, and the AutoCAD is used to quickly acquire the coordinate data of the first and second endpoints, the first radius data of the first node and the second radius data of the second node of all lofting line segments in the design drawing.

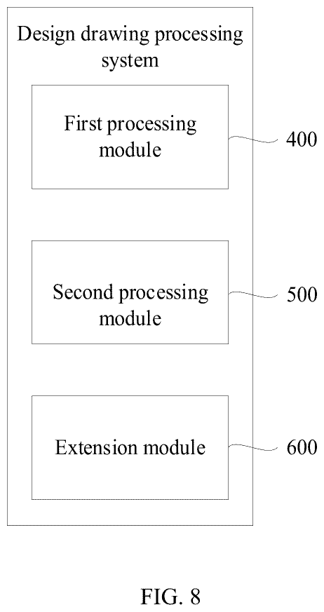

As shown in FIG. 8, an embodiment of the present disclosure further provides a system for processing a design drawing, which includes:
a first processing module 400 configured for acquiring, from a target application, first coordinate data of a first endpoint, second coordinate data of a second endpoint, first radius data of a first node and second radius data of a second node:
a second processing module 500 configured for obtaining first circle-center coordinate data of the first node according to the first coordinate data, the second coordinate data and the first radius data; and obtaining second circle-center coordinate data of the second node according to the first coordinate data, the second coordinate data and the second radius data; and
an extension module 600 configured for performing a first connection operation on a lofting line segment according to the first circle-center coordinate data and the first coordinate data, and performing a second connection operation on the lofting line segment according to the second circle-center coordinate data and the second coordinate data.

It can be seen that all the contents of the method for processing a design drawing in the above embodiment are applicable to the system for processing a design drawing in this embodiment, the functions specifically realized by the system for processing a design drawing in this embodiment are the same as those realized by the method for processing a design drawing in the above embodiment, and the beneficial effects achieved by the system for processing a design drawing in this embodiment are the same as those achieved by the method for processing a design drawing in the above embodiment.

An embodiment of the present disclosure further provides an electronic device, which includes: at least one processor, and a memory in communication connection with the at least one processor; wherein, the memory stores instructions which, when executed by the at least one processor, cause the at least one processor to implement the method for processing a design drawing described in any one of the embodiments above.

An embodiment of the present disclosure further provides a computer-readable storage medium, wherein the computer-readable storage medium stores computer-executable instructions for enabling a computer to execute the method for processing a design drawing described in any one of the embodiments above.

The system embodiments described above are only illustrative, wherein the units described as separate components may or may not be physically separated, which means that the units may be located in one place or distributed to multiple network units. Some or all of the modules may be selected according to actual needs to achieve the objectives of the solutions in the embodiments.

Those of ordinary skills in the art can understand that all or some of steps in the method, and the system disclosed above can be implemented as software, firmware, hardware and appropriate combinations thereof. Some or all of the physical components can be implemented as software executed by a processor, such as a central processing unit, a digital signal processor or a microprocessor, or implemented as hardware, or implemented as an integrated circuit, such as an application-specific integrated circuit. Such software can be distributed on a computer-readable medium, and the computer-readable medium may include a computer storage medium (or a non-transitory medium) and a communication medium (or a transitory medium). It is well known to those of ordinary skills in the art that the term “computer storage medium’ includes a volatile and nonvolatile, removable and non-removable medium implemented in any method or technology for storing information (such as a computer readable instruction, a data structure, a program module, or other data). The computer storage media include but are not limited to RAM. ROM. EEPROM, flash storage or other storage technologies, CD-ROM, digital versatile disk (DVD) or other optical disk storage, magnetic box, magnetic tape, magnetic disk storage or other magnetic storage devices, or any other media capable of being used to store desired information and accessed by a computer. Furthermore, it is well known to those of ordinary skills in the art that the communication media typically include a computer readable instruction, a data structure, a program module or other data in a modulated data signal such as a carrier wave or other transmission mechanism, and may include any information delivery medium.

The embodiments of the present disclosure are described in detail with reference to the drawings above, but the present disclosure is not limited to the above embodiments, and various changes may also be made within the knowledge scope of those of ordinary skills in the art without departing from the purpose of the present disclosure. In addition, the embodiments of the present disclosure and the features in the embodiments may be combined with each other without conflict.

1. A method for processing a design drawing, wherein the design drawing comprises a plurality of connection assemblies, each of the connection assemblies comprises a first node, a second node and a lofting line segment, the lofting line segment comprises a first endpoint and a second endpoint, the first endpoint is connected with the first node, the second endpoint is connected with the second node, and the first node and the second node are both circular, and the method comprises:
acquiring, from a target application, first coordinate data of the first endpoint, second coordinate data of the second endpoint, first radius data of the first node and second radius data of the second node;
obtaining first circle-center coordinate data of the first node according to the first coordinate data, the second coordinate data and the first radius data;
obtaining second circle-center coordinate data of the second node according to the first coordinate data, the second coordinate data and the second radius data; and
performing a first connection operation on the lofting line segment according to the first circle-center coordinate data and the first coordinate data, and performing a second connection operation on the lofting line segment according to the second circle-center coordinate data and the second coordinate data.

2. The method for processing a design drawing according to claim 1, wherein obtaining the first circle-center coordinate data of the first node according to the first coordinate data, the second coordinate data and the first radius data, comprises:
obtaining length data of the lofting line segment according to the first coordinate data and the second coordinate data; and
obtaining the first circle-center coordinate data of the first node according to the length data, the first radius data and the first coordinate data.

3. The method for processing a design drawing according to claim 2, wherein the length data comprises first line segment length data, first projection length data and second projection length data; wherein, the first projection length data is used for representing projection length data of the lofting line segment in a first direction, the second projection length data is used for representing projection length data of the lofting line segment in a second direction, and the second direction is perpendicular to the first direction; and obtaining the first circle-center coordinate data of the first node according to the length data and the first radius data, comprises:
obtaining third projection length data and fourth projection length data according to the first line segment length data, the first projection length data, the second projection length data and the first radius data; wherein, the third projection length data is used for representing projection length data of a radius of the first node in the first direction, and the fourth projection length data is used for representing projection length data of the radius of the first node in the second direction; and
obtaining the first circle-center coordinate data of the first node according to the third projection length data, the fourth projection length data and the first coordinate data.

4. The method for processing a design drawing according to claim 3, wherein obtaining the second circle-center coordinate data of the second node according to the first coordinate data, the second coordinate data and the second radius data, comprises:
obtaining length data of the lofting line segment according to the first coordinate data and the second coordinate data; and
obtaining the second circle-center coordinate data of the second node according to the length data, the second radius data and the second coordinate data.

5. The method for processing a design drawing according to claim 4, wherein obtaining the second circle-center coordinate data of the second node according to the length data, the second radius data and the second coordinate data, comprises:
obtaining fifth projection length data and sixth projection length data according to the first line segment length data, the first projection length data, the second projection length data and the second radius data; wherein, the fifth projection length data is used for representing projection length data of a radius of the second node in the first direction, and the sixth projection length data is used for representing projection length data of the radius of the second node in the second direction; and
obtaining the second circle-center coordinate data of the second node according to the fifth projection length data, the sixth projection length data and the second coordinate data.

6. The method for processing a design drawing according to claim 1, wherein the target application comprises AutoCAD.

7. A system for processing a design drawing, comprising:
a first processing module configured for acquiring, from a target application, first coordinate data of a first endpoint, second coordinate data of a second endpoint, first radius data of a first node and second radius data of a second node;
a second processing module configured for obtaining first circle-center coordinate data of the first node according to the first coordinate data, the second coordinate data and the first radius data; and obtaining second circle-center coordinate data of the second node according to the first coordinate data, the second coordinate data and the second radius data; and
an extension module configured for performing a first connection operation on a lofting line segment according to the first circle-center coordinate data and the first coordinate data, and performing a second connection operation on the lofting line segment according to the second circle-center coordinate data and the second coordinate data.

8. An electronic device, comprising:
at least one processor, and a memory in communication connection with the at least one processor;
wherein, the storage stores instructions which, when executed by the at least one processor, cause the at least one processor to implement the method for processing a design drawing according to claim 1.

9. A non-transitory computer-readable storage medium, wherein the computer-readable storage medium stores computer-executable instructions for enabling a computer to execute the method for processing a design drawing according to claim 1.
